(19) United States
(12) Patent Application Publication
(10) Pub. No.: US 2026/0152418 A1
(43) Pub. Date: Jun. 4, 2026

(54) METHOD FOR REMOVING ORGANIC MATTER FROM WATER USING ELECTROCHEMICAL-OZONE COUPLING SYSTEM BASED ON LDH-LOADED GRAPHITE FELT CATHODE

(71) Applicants: INNOVATION CENTER OF YANGTZE RIVER DELTA, ZHEJIANG UNIVERSITY, Jiaxing City (CN); ZHEJIANG UNIVERSITY, Hangzhou (CN)

(72) Inventors: YAN ZHANG, JIAXING CITY (CN); ZEKUN DONG, HANGZHOU (CN); TUQIAO ZHANG, JIAXING CITY (CN); HUIMING XIANG, JIAXING CITY (CN)

(21) Appl. No.: 19/383,438

(22) Filed: Nov. 7, 2025

(30) Foreign Application Priority Data
Nov. 29, 2024 (CN) 202411732019.5

(51) Int. Cl. C02F 1/461; C02F 1/467; C02F 1/66; C02F 101/34; C23C 18/04; C23C 18/12

(52) U.S. Cl. CPC C02F 1/46109; C02F 1/4672; C02F 1/66; C23C 18/04; C23C 18/1204; C23C 18/1245; C23C 18/1266; C23C 18/1279; C02F 2001/46142; C02F 2101/34; C02F 2305/023

(57) ABSTRACT

The present invention discloses a method for removing organic matter from water using an electrochemical-ozone coupling system based on an LDH-loaded graphite felt cathode. The method includes: using MFe-LDH/GF as a cathode, wherein M is Cu, Mn, Co, or Ni; using a platinum sheet as an anode; using a reaction solution including a pollutant and an electrolyte, wherein the electrolyte is Na₂SO₄; adding the two electrodes into the reaction solution, and introducing gas-phase ozone into the reaction solution; adjusting a pH of the reaction solution to 3-9; and introducing a current to the two electrodes to construct the electrochemical-ozone coupling system to remove the pollutant. By means of the method, the yield of HO· can be increased, thereby enhancing the removal of organic pollutants.

### TECHNICAL FIELD

The present invention belongs to the field of catalytic ozonation and organic matter removal, and particularly relates to a method for removing organic matter from water using an electrochemical-ozone coupling system based on an layered double metal hydroxide (LDH)-loaded graphite felt cathode.

### BACKGROUND ART

With rapid development of the modern industry and widespread use of chemicals, a large amount of organic wastewater generated by the industry, agriculture, medicine, and human activities has not been effectively treated, and has caused severe chemical pollution to available water resources after being discharged into natural water bodies. These artificially synthesized organic pollutants usually have good chemical stability, higher toxicity, and bioaccumulation, thus making them difficult to effectively remove by conventional water treatment processes, such as coagulation, filtration, and biological action. Advanced oxidation and other deep treatment technologies are often required to meet treatment requirements.

An electrochemical-ozone coupling technology is an emerging advanced oxidation process for water treatment that combines electrochemistry and ozone. A carbon-based cathode in the system can ingeniously reduce O₂ in mixed gas produced by an ozone generator to H₂O₂, thereby initiating a peroxidation reaction between H₂O₂ and O₃ to generate a large amount of HO·, which compensates for the deficiencies of low treatment efficiency of electrochemical oxidation and poor mineralization rate of ozonation. Furthermore, compared with electrochemical oxidation, electro-Fenton oxidation, and O₃/H₂O₂ technologies, electrochemical-ozone coupling not only significantly improves pollutant removal efficiency, but also reduces a safety risk of H₂O₂ during transportation and storage, thus being a safer and more convenient water treatment technology.

An invention patent application with publication No. CN113184951A discloses a modification method applicable to a graphite felt cathode in an electro-perozonation system and use thereof. The method includes the processes of performing pretreatment to remove impurities on a surface of graphite felt, and performing anodic oxidation on the graphite felt in a neutral sodium sulfate electrolyte, thereby improving the hydrophilicity of the graphite felt, increasing the content of an oxygen-containing functional group on the surface, and increasing active sites for reduction of oxygen to hydrogen peroxide. Accordingly, the production of hydrogen peroxide in the electro-perozonation system is increased, and the ability to remove oxalic acid is enhanced. It is noteworthy that although increasing the content of the oxygen-containing functional group on the surface of the graphite felt leads to an increase in catalytic sites of ozone, since the modified graphite felt in the electro-perozonation system is protected by a cathode current, corrosion and damage caused by the ozone to a surface of an electrode are greatly reduced, and the stability of the electrode is enhanced.

A patent application with publication No. CN113371798A discloses a method for catalytic removal of a chemical oxygen demand in wastewater using ozone-electro-Fenton coupling. In the system for catalytic removal of the chemical oxygen demand in the wastewater using the electro-Fenton method, an anode adopts an inert anode and iron to serve as a contact-type dual anode, and a cathode adopts graphite felt. Alternatively, the anode adopts iron as the anode, and the cathode adopts graphite felt. Alternatively, the anode adopts an inert anode, the cathode adopts iron and graphite felt to serve as a contact-type dual cathode, and an electrolyte solution is sewage to be degraded to construct an electro-Fenton system, which is externally connected with a constant direct current and externally connected with an ozone generator for introducing ozone to the cathode.

However, compared with the patent applications disclosed above, carbon cathode materials commonly used in the electrochemical-ozone coupling technology have a relatively single function and only play the role of generating H₂O₂, and H₂O₂ diffused into a solution inevitably participates in the competition for HO·. Therefore, it is necessary to develop a functional carbon cathode having the effect of catalyzing H₂O₂ and O₃ to enhance the yield and utilization rate of HO· in an electrochemical-ozone coupling system and enhance a removal effect of organic pollutants.

### SUMMARY OF THE INVENTION

The present invention provides a method for removing organic matter from water using an electrochemical-ozone coupling system based on an LDH-loaded graphite felt cathode. By means of the method, the yield of HO· can be increased, thereby enhancing the removal of organic pollutants.

The present invention provides a method for removing organic matter from water using an electrochemical-ozone coupling system based on an LDH-loaded graphite felt (GF) cathode, which includes:
using MFe-LDH/GF as a cathode, wherein M is Cu, Mn, Co, or Ni; using a platinum sheet as an anode; using a reaction solution including a pollutant and an electrolyte, wherein the electrolyte is Na₂SO₄; adding the two electrodes into the reaction solution, and introducing gas-phase ozone into the reaction solution; adjusting a pH of the reaction solution to 3-9; and introducing a current to the two electrodes to construct the electrochemical-ozone coupling system to remove the pollutant.

Preferably, the MFe-LDH/GF is used as the cathode, wherein M is Cu. Due to a higher electroactive area, Cu can more effectively suppress the generation of H₂O₂, and meanwhile generate more O₂·⁻ to react with ozone to form more HO·, thereby further enhancing the removal efficiency of organic matter.

Preferably, the pH of the reaction solution is 5-7. In the present invention, by controlling the pH value of the reaction solution, appropriate amounts of metals are dissolved out to participate in the reaction of generating HO·, and meanwhile, to reduce structural collapse caused by the dissolution of the metals due to an excessively low pH value during long-term catalysis, thereby affecting reaction stability.

Preferably, the density of the current introduced to the two electrodes is 2-5 mA/cm².

Preferably, the concentration of the gas-phase ozone is 15-60 mg/L, and the flow velocity of the gas-phase ozone is 100-300 mL/min.

Preferably, in the reaction solution, the concentration of Na₂SO₄ is 30-70 mmol/L, and the concentration of the pollutant is 30-60 mg/L.

Preferably, the pollutant is oxalic acid, pyruvic acid, or acetic acid.

Since small molecular organic acids (such as oxalic acid, pyruvic acid, acetic acid, etc.) have extremely low reaction rates with the ozone and are common degradation products in the treatment of organic wastewater using advanced oxidation technologies to restrict the degree of mineralization of the organic wastewater, the oxalic acid is selected as a model pollutant in specific examples of the present invention to evaluate the removal efficiency of organic matter using the electrochemical-ozone coupling system.

Preferably, H₂SO₄ and NaOH are added into the reaction solution to adjust the pH value, a concentration of H₂SO₄ is 0.05-0.2 mol/L, and a concentration of NaOH is 0.05-0.2 mol/L.

Preferably, a method for preparing the MFe-LDH/GF includes:
thoroughly dissolving Fe(NO₃)₃·9H₂O, M(NO₃)₂·xH₂O, CO(NH₂)₂, and NH₄F in ultrapure water to obtain an LDH mother solution, wherein mass concentrations of Fe(NO₃)₃·9H₂O, M(NO₃)₂·xH₂O, CO(NH₂)₂, and NH₄F are 9-23 g/L, 13-26 g/L, 20-35 g/L, and 1-3 g/L, respectively; and
adding graphite felt into the LDH mother solution to obtain a mixed solution, allowing the mixed solution to undergo a hydrothermal reaction at a temperature of 90-120° C. for a reaction time of 8-16 hours, and after the reaction is completed, performing suction filtration, washing, and drying to obtain the MFe-LDH/GF.

In the present invention, by controlling the reaction temperature and the reaction time, urea is thoroughly decomposed, and the collapse of a layered structure caused by an excessively high temperature is avoided. Meanwhile, the urea is avoided from being decomposed into a large amount of ammonia gas that forms a complex with M ions and is not conducive to the formation of an LDH catalyst. In the present invention, by controlling the concentrations of various added substances, the formation of an LDH crystal is ensured, and impurity generation and metal outflow are reduced.

Preferably, in the present invention, by controlling a molar ratio of Fe to M to be 2:1 to 3:1 and the mass concentrations of CO(NH₂)₂ and NH₄F to be 28.5 g/L and 2.1 g/L, respectively, a removal effect of organic pollutants is optimal.

Preferably, before the graphite felt is added into the LDH mother solution, a surface of the graphite felt is sequentially washed with acetone and ultrapure water, dried, and oven-dried. Oil stains and impurities on the surface of the graphite felt are removed by the above operations.

Preferably, a reacted material is ultrasonically washed repeatedly with ethanol and ultrapure water until a washing solution is neutral.

Compared with the prior art, the present invention has the following beneficial effects.

By using the MFe-LDH/GF as the cathode in the present invention, the generation of H₂O₂ is suppressed, and meanwhile, a large amount of O₂·⁻ is generated to replace H₂O₂ in reacting with the ozone to form HO·, thereby reducing a quenching effect of H₂O₂ on HO·. Meanwhile, by controlling the pH value of the reaction solution in the present invention, the metals are partially dissolved out to react with the ozone to obtain HO·. Therefore, based on the above two points, the method provided by the present invention greatly enhances the removal efficiency of organic matter.

### BRIEF DESCRIPTION OF THE DRAWINGS

FIG. 1 is an X-ray diffraction diagram of GF and CuFe-LDH/GF cathodes provided in Example 1 of the present invention;

FIG. 2 shows scanning electron microscopy images of CuFe-LDH powder and the CuFe-LDH/GF cathode provided in Example 1 of the present invention;

FIG. 3 is a schematic diagram of a reaction device of an electrochemical-ozone coupling system provided in Example 2 of the present invention;

FIG. 4 is a diagram showing removal effects of ozonation, anodic oxidation, and electrochemical-ozone coupling systems with different cathodes on oxalic acid provided in Examples 2-5 and Comparative Examples 1-2 of the present invention;

FIG. 5 shows electrochemical active areas of different LDH cathodes provided in Examples 2-5 of the present invention;

FIG. 6 is a diagram showing impacts of quenchers on removal efficiency of oxalic acid provided in Example 6 of the present invention;

FIG. 7 is a diagram showing impacts of metal molar ratios and preparation temperatures on removal efficiency of oxalic acid provided in Example 7 of the present invention;

FIG. 8 is a diagram showing an impact of a pH of a solution on removal efficiency of oxalic acid provided in Example 8 of the present invention;

FIG. 9 shows the stability of removing oxalic acid (OA) in an EP system using CuFe-LDH/GF as a cathode provided in Example 9 of the present invention; and

FIG. 10 is a diagram showing removal effects of ozonation and electrochemical-ozone coupling systems with different cathodes on dissolved organic carbon in nanofiltration concentrated water provided in Example 10 of the present invention.

### DETAILED DESCRIPTION OF THE EMBODIMENTS

A layered double metal hydroxide (LDH) used in specific examples of the present invention, serving as a two-dimensional layered clay structure of a regular octahedron, has various metal layers and adjustable interlayer anions, and has been widely used in fields, such as catalysis, adsorption, and drug delivery. Therefore, using an LDH-loaded carbon cathode with high catalytic activity and a large specific surface area is conducive to enhancing the utilization efficiency of H₂O₂ and 03 in an electrochemical-ozone coupling system, promoting the formation of active species, and accelerating the removal of organic pollutants.

The present invention is further described and explained below in conjunction with the accompanying drawings and specific embodiments. Technical features of various embodiments of the present invention may be appropriately combined, provided that there is no mutual conflict.

### Example 1

A CuFe-LDH/GF cathode applicable to an electrochemical-ozone coupling system includes the following synthesis steps:
(1) cutting commercially purchased graphite felt into 2 cm×4 cm, sequentially washing the same with acetone and ultrapure water for 20 minutes to remove oil stains and impurities on a surface, and then placing the washed graphite felt in a constant-temperature drying oven for oven-drying at 60° C. for 24 hours for later use;
(2) thoroughly dissolving 0.808 g of Fe(NO₃)₃·9H₂O, 1.449 g of Cu(NO₃)₂·3H₂O, 2 g of CO(NH₂)₂, and 0.247 g of NH₄F in 70 mL of ultrapure water to obtain an LDH mother solution; and
(3) immersing the spare graphite felt in the step (1) in the LDH mother solution in the step (2) to remove air bubbles within pores of the graphite felt; then jointly transferring the LDH mother solution and the graphite felt into a stainless steel reactor equipped with a polytetrafluoroethylene liner, and placing a resulting mixture in an oven, where a reaction temperature and a time are set at 90° C. and 12 hours, respectively; after the treatment is completed, separating LDH powder and LDH-loaded graphite felt by a suction filtration manner, and ultrasonically washing the material repeatedly with ethanol and ultrapure water until a washing solution is neutral; and placing the cleaned LDH-loaded graphite felt in a vacuum drying oven for oven-drying at 50° C., which is denoted as CuFe-LDH/GF. The cathode has the following characteristics.

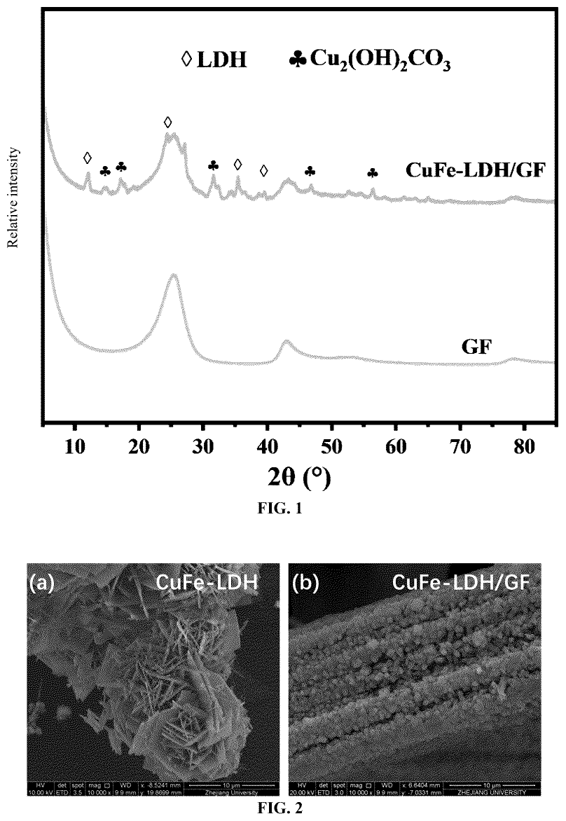

As shown in FIG. 1, a diffraction peak at 26.3° corresponds to plane 002 of the graphite felt (GF), while diffraction peaks at 11.5°, 23.1°, 34.1°, and 38.7° correspond to crystal faces (003), (006), (012), and (015) of the CuFe-LDH/GF cathode, respectively, indicating that CuFe-LDH was successfully synthesized and loaded onto the surface of the graphite felt. Furthermore, a Cu₂(OH)₂CO₃ crystal (JCPDF #01-072-8421) was also found in the CuFe-LDH/GF cathode. This was because urea also released CO₂ while providing an alkali source during hydrothermal synthesis, leading to the combination of metal ions and carbonate radicals and the formation of a malachite structure. Part (a) and Part (b) in FIG. 2 show that the CuFe-LDH powder exhibited a typical layered structure, and exhibited small granular sheets after being loaded onto the graphite felt, further confirming that the CuFe-LDH/GF cathode was successfully synthesized.

Table 1 shows specific surface area and pore parameters of the GF and the CuFe-LDH/GF. It can be seen that after loading modification of the GF with the CuFe-LDH, the BET specific surface area was increased by 0.61 m²/g, which was conducive to improving the adsorption capacity of the cathode. Furthermore, the GF had a smaller average pore diameter and mainly included micropores. Meanwhile, the CuFe-LDH/GF had a larger average pore diameter, which was conducive to making a reactant diffuse to catalytic sites and improving the mass transfer efficiency between the cathode and the solution.

TABLE 1
Specific surface area and pore parameters

| | GF | CuFe-LDH/GF |
|---|---|---|
| BET (m²/g) | 0.96 | 1.57 |
| Micropore area (m²/g) | 0.66 | 0.69 |
| Total pore volume (cm³/g) | 0.0014 | 0.0070 |
| Average pore diameter (nm) | 5.73 | 17.80 |

### Example 2

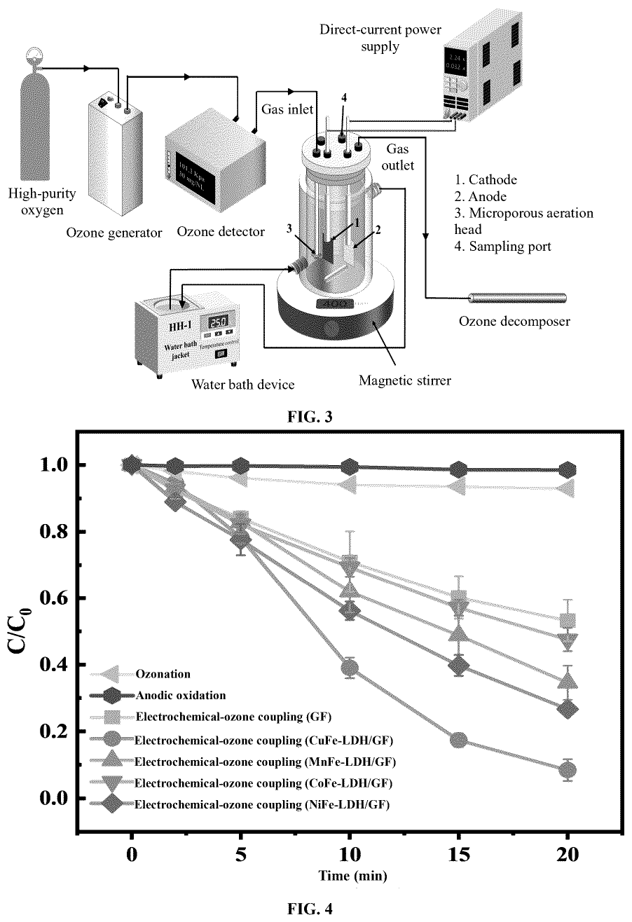

This example investigated a removal effect of an electrochemical-ozone coupling system using CuFe-LDH/GF as a cathode on oxalic acid, referring to FIG. 3. An ozone generator adopted high-purity oxygen as a gas source, and generated gas-phase O₃ was introduced into a reaction tank through a microporous aeration head after concentration analysis using an ozone detector. The gas-phase O₃ was evenly dissolved in a reaction solution using a magnetic stirrer, and the reaction temperature was controlled by a water bath pot. A gas outlet of the reaction tank was connected to an ozone decomposer to destroy undissolved gas-phase O₃. A direct-current power supply was adopted to provide a constant current density. All gas guide pipes in a reaction device adopted ozone-resistant rubber pipes. Specific steps include the following:
(1) using the CuFe-LDH/GF in Example 1 as a cathode and a platinum sheet (2×4 cm) as an anode, where a distance between the cathode and the anode is 2 cm;
(2) using a reaction solution with a volume of 400 mL and containing 30 mg/L oxalic acid and 50 mmol/L Na₂SO₄, adjusting an initial pH of the solution to 7 using 0.1 mol/L H₂SO₄ and 0.1 mol/L NaOH, adjusting a concentration of gas-phase ozone to 30 mg/L, adjusting a gas flow velocity to 200 mL/min⁻¹, and adjusting a water bath temperature to 25° C.; and
(3) using a direct-current power supply to provide a current density of 2 mA/cm², setting a power-on duration at 20 minutes, extracting 1 mL of the reaction solution within a predetermined time, and detecting the concentration of oxalic acid remaining in water by a high performance liquid chromatograph.

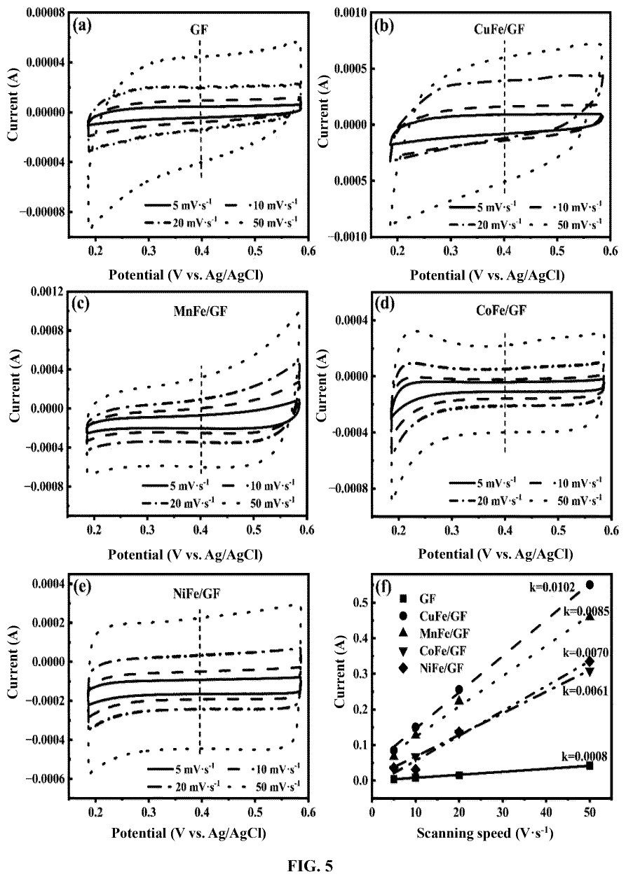

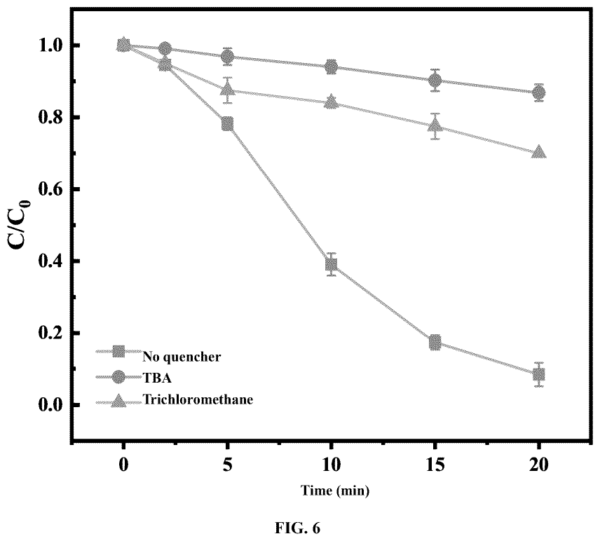

As shown in FIG. 4, the removal rate of oxalic acid in this example was 91.2%.

### Comparative Example 1

As shown in FIG. 4, when the ozone generator was not turned on and all other steps are the same as those in Example 2, the oxalic acid could hardly be removed within 20 minutes by relying solely on an oxidation effect of the platinum anode. When no current was applied and all other steps were the same as those in Example 2, only 7.0% of the oxalic acid could be removed within 20 minutes by relying on an oxidation effect of the ozone. The results indicated that the removal effect of the electrochemical-ozone coupling system using the CuFe-LDH/GF as the cathode on the oxalic acid was far superior to a sum of individual anodic oxidation efficiency and individual ozonation efficiency.

### Comparative Example 2

As shown in FIG. 4, when the graphite felt (GF) in the step 1 of Example 1 was used to replace the CuFe-LDH/GF cathode and all other steps were the same as those in Example 2, 46.8% of the oxalic acid could be removed within 20 minutes, which was still much lower than that of the electrochemical-ozone coupling system using the CuFe-LDH/GF as the cathode.

### Examples 3-5

In Examples 3-5, MnFe-LDH/GF, CoFe-LDH/GF, and NiFe-LDH/GF were used as a cathode to replace the CuFe-LDH/GF in Example 2, respectively, and electrochemical-ozone coupling systems constructed in Examples 3-5 all exhibited a good oxalic acid removal capability, but were still inferior to the electrochemical-ozone coupling system using the CuFe-LDH/GF as the cathode, indicating that the selection of a divalent metal of the LDH-loaded graphite felt cathode in the system affected the removal efficiency of oxalic acid. As shown in Parts (a)-(f) in FIG. 5, according to cyclic voltammetry curves at different scanning rates, the CuFe-LDH/GF cathode had a highest double-layer capacitance (10200 μF) among the four Fe-based LDH cathodes, indicating that it had a largest electroactive area, thus facilitating the occurrence of a reduction reaction at the cathode and the formation of active species.

A method for preparing the MnFe-LDH/GF, CoFe-LDH/GF, and NiFe-LDH/GF cathodes was similar to that of the CuFe-LDH/GF cathode. According to a molar ratio of the divalent metal (such as Cu, Mn, Co, or Ni) to the trivalent metal (Fe) being 0.006 mol:0.002 mol in an LDH preparation process, Cu(NO₃)₂·3H₂O in Example 1 was replaced with 1.506 g of Mn(NO₃)₂·4H₂O, 1.746 g of Co(NO₃)₂·6H₂O, and 1.744 g of Ni(NO₃)₂·6H₂O, respectively.

### Example 6

This example explored an action mechanism of an electrochemical-ozone coupling system using CuFe-LDH/GF as a cathode for the removal of oxalic acid, which specifically includes the following steps:
(1) using the CuFe-LDH/GF in Example 1 as a cathode and a platinum sheet (2×4 cm) as an anode, where a distance between the cathode and the anode is 2 cm;
(2) using a reaction solution with a volume of 400 mL and containing 30 mg/L oxalic acid and 50 mmol/L Na₂SO₄ as an electrolyte, adjusting an initial pH of the solution to 7 using 0.1 mol/L H₂SO₄ and 0.1 mol/L NaOH, adjusting a concentration of gas-phase ozone to 30 mg/L, adjusting a gas flow velocity to 200 mL/min⁻¹, adjusting a water bath temperature to 25° C., and adding 20 mmol/L tertiary butanol as a quencher for HO· and 20 mmol/L trichloromethane as a quencher for O₂·⁻; and
(3) using a direct-current power supply to provide a current density of 2 mA/cm², setting a power-on duration at 20 minutes, extracting 1 mL of the reaction solution within a predetermined time, and detecting the concentration of oxalic acid remaining in water by a high performance liquid chromatograph.

As shown in FIG. 6, after the 20 mmol/L tertiary butanol (TBA) was added into the system, the degradation efficiency of oxalic acid was obviously inhibited, and a removal rate was decreased from 91.2% to 13.2%, indicating that HO· is a main active species for degrading the oxalic acid. After the 20 mmol/L trichloromethane was added into the system, the removal rate of oxalic acid is decreased by 61.6%, indicating that O₂·⁻ was also an important active species during the degradation of the oxalic acid. However, O₂·⁻ only had a redox potential of 1.0 V and could hardly oxidize the oxalic acid, so that it might play a crucial role during the formation of HO·.

Furthermore, when only O₂ was introduced and a current was applied without introducing the ozone, the GF cathode may generate 11 mg/L H₂O₂ within 20 minutes, while the H₂O₂ production of the CuFe-LDH/GF cathode was only 1.6 mg/L. The above results indicated that loading CuFe-LDH changed a reduction pathway of O₂ on the GF cathode, and O₂·⁻ generated on the cathode replaces H₂O₂ to react with the ozone to form HO· (formulas 1-3), thereby reducing a quenching effect of H₂O₂ on HO· and greatly enhancing the removal efficiency of oxalic acid.

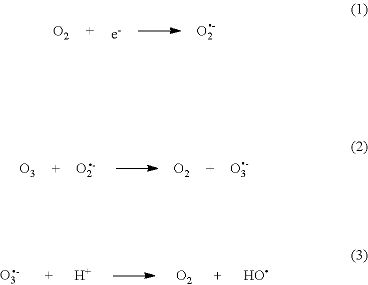

### Example 7

This example investigated impacts of preparation parameters of the CuFe-LDH/GF cathode on the removal of oxalic acid, which specifically includes the following steps:
(1) preparing CuFe-LDH/GF cathodes at different Cu to Fe molar ratios (with a total metal amount of 0.008 mol) using the steps in Example 1, where except that the addition amounts of metal salts during preparation of the LDH mother solution are different, other steps remain unchanged, and when the Cu to Fe molar ratios are 0:1, 1:1, 2:1, 3:1, 4:1, and 1:0, the addition amounts of Fe(NO₃)₃·9H₂O and Cu(NO₃)₂·3H₂O are 3.232 g and 0 g, 1.616 g and 0.966 g, 1.077 g and 1.288 g, 0.808 g and 1.449 g, 0.646 g and 1.546 g, and 0 g and 1.933 g, respectively;
(2) preparing CuFe-LDH/GF cathodes at different synthesis temperatures using the steps in Example 1, where except that the synthesis temperatures are 70° C., 90° C., 120° C., and 140° C., respectively, other steps remain unchanged;
(3) using the CuFe-LDH/GF prepared in this example as a cathode and a platinum sheet (2×4 cm) as an anode, where a distance between the cathode and the anode is 2 cm; and using a reaction solution with a volume of 400 mL and containing 30 mg/L oxalic acid and 50 mmol/L Na₂SO₄ as an electrolyte, adjusting an initial pH of the solution to 7 using 0.1 mol/L H₂SO₄ and 0.1 mol/L NaOH, adjusting a concentration of gas-phase ozone to 30 mg/L, adjusting a gas flow velocity to 200 mL/min⁻¹, and adjusting a water bath temperature to 25° C.; and
(4) using a direct-current power supply to provide a current density of 2 mA/cm², setting a power-on duration at 20 minutes, extracting 1 mL of the reaction solution within a predetermined time, and detecting the concentration of oxalic acid remaining in water by a high performance liquid chromatograph.

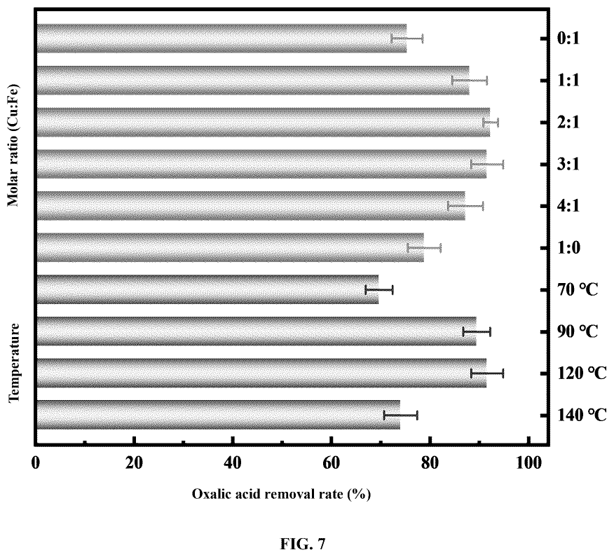

As shown in FIG. 7, under the condition that the total metal amount remains unchanged during the preparation process, the GF cathode loaded individually with either Cu or Fe had a relatively poor removal effect on the oxalic acid in the electrochemical-ozone coupling system, which was 75.4% and 78.8%, respectively, but was still higher than that of the unloaded GF cathode (46.8%). After the two metal elements were added and when the Cu to Fe molar ratio is 2:1 or 3:1, the removal effect on the oxalic acid was optimal, which was consistent with an optimal M²⁺ to M³⁺ ratio reported in a document. As the preparation temperature increased from 70° C. to 120° C., the removal rate of oxalic acid increased from 67.8% to above 90%. This was because a higher preparation temperature may accelerate the decomposition of urea and promote a rapid increase in the pH of the solution, thereby more effectively forming an LDH catalyst. When the temperature was further increased to 140° C., the removal rate of oxalic acid was significantly reduced. This may be because a high temperature led to the collapse of a layered structure, thereby affecting the catalytic activity of LDH. Furthermore, it was found during the preparation process that when the temperature was 90° C. or 120° C., a filtrate obtained at the end of preparation was colorless, while the filtrate at 140° C. was deep blue. This was because the urea was decomposed into a large amount of ammonia gas (NH₃) at a high temperature, which ultimately formed a copper-ammonia complex ([Cu(NH₃)₄]²⁺) with Cu ions and was not conducive to the formation of the LDH catalyst. Therefore, the CuFe-LDH/GF cathode had an optimal Cu to Fe molar ratio of 3:1 and an optimal hydrothermal temperature of 120° C.

### Example 8

Since a pH of a solution is a critical influencing factor in an electrochemical-ozone coupling system, this example investigated an impact of the pH of a solution in an electrochemical-ozone coupling system using CuFe-LDH/GF as a cathode on the removal of oxalic acid, which specifically includes the following steps:
(1) using the CuFe-LDH/GF in Example 1 as a cathode and a platinum sheet (2×4 cm) as an anode, where a distance between the cathode and the anode is 2 cm;
(2) using a reaction solution with a volume of 400 mL and containing 30 mg/L oxalic acid and 50 mmol/L Na₂SO₄ as an electrolyte, adjusting an initial pH of the solution to 3-11 using 0.1 mol/L H₂SO₄ and 0.1 mol/L NaOH, adjusting a concentration of gas-phase ozone to 30 mg/L, adjusting a gas flow velocity to 200 mL/min⁻¹, and adjusting a water bath temperature to 25° C.; and
(3) using a direct-current power supply to provide a current density of 2 mA/cm², setting a power-on duration at 20 minutes, extracting 1 mL of the reaction solution within a predetermined time, and detecting the concentration of oxalic acid remaining in water by a high performance liquid chromatograph.

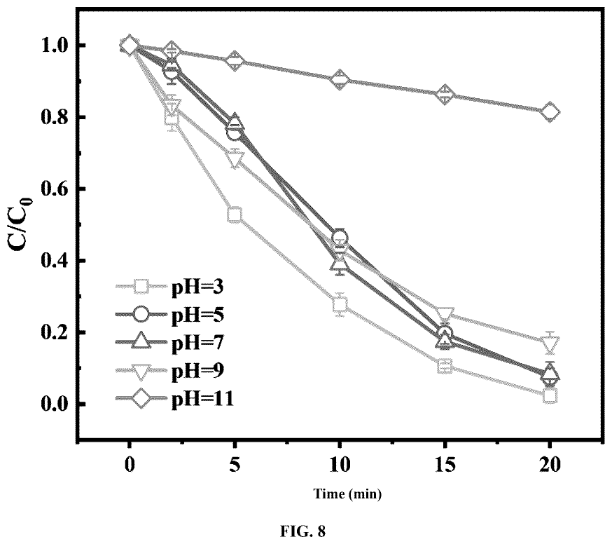

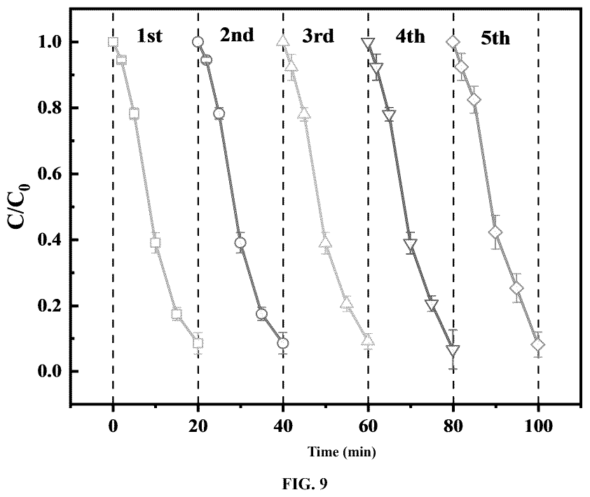

As shown in FIG. 8, when the initial pH of the solution was 3.0, the removal rate of oxalic acid of the system of the present invention approached 100% within 20 minutes. When the pH of the solution was increased to 5.0-9.0, the removal rate of oxalic acid was 86.0%-92.6%. When the initial pH of the solution was increased to 11.0, the removal rate of oxalic acid was only about 20%. This was because O₃ was difficult to accumulate and CO₃²⁻ quenched HO·. In summary, the system of the present invention exhibited a good oxalic acid removal capability within a solution pH range of 3.0-9.0, which solved the problem of poor performance of conventional electrochemical coupling systems under acidic conditions.

### Example 9

This example investigated the stability of removing oxalic acid in an electrochemical-ozone coupling system using CuFe-LDH/GF as a cathode, which specifically includes the following steps:
(1) using the CuFe-LDH/GF in Example 1 as a cathode and a platinum sheet (2×4 cm) as an anode, where a distance between the cathode and the anode is 2 cm;
(2) using a reaction solution with a volume of 400 mL and containing 30 mg/L oxalic acid and 50 mmol/L Na₂SO₄ as an electrolyte, adjusting an initial pH of the solution to 7.0 using 0.1 mol/L H₂SO₄ and 0.1 mol/L NaOH, adjusting a concentration of gas-phase ozone to 30 mg/L, adjusting a gas flow velocity to 200 mL/min⁻¹, and adjusting a water bath temperature to 25° C.; and
(3) using a direct-current power supply to provide a current density of 2 mA/cm², setting a power-on duration at 20 minutes, extracting 1 mL of the reaction solution within a predetermined time, and detecting the concentration of oxalic acid remaining in water by a high performance liquid chromatograph.

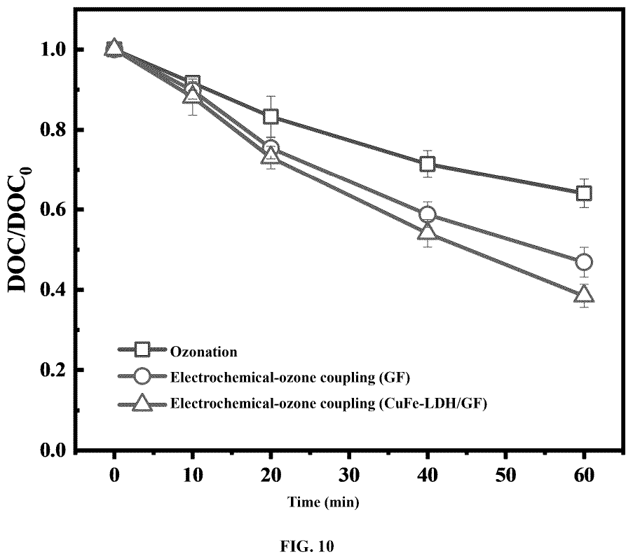

As shown in FIG. 9, after repeated use of a CuFe/GF cathode 5 times, the removal rate of oxalic acid was not obviously decreased. Furthermore, leaching amounts of Cu and Fe elements in a repeated test were both <0.06 mg L⁻¹, which met the National Hygienic Standard for Drinking Water (GB5749-2022). The excellent stability of an EP-CuFe/GF system may be attributed to two aspects: on one hand, a Cu or Fe hydroxide in LDH has a higher Ksp, thus being difficult to dissolve under neutral conditions; and on the other hand, due to a cathode protection effect, a surface structure of the CuFe/GF cathode was not easily damaged by O₃. Therefore, the EP-CuFe/GF can continuously and efficiently degrade the oxalic acid under neutral conditions, which laid a foundation for practical application of the technology.

### Example 10

This example investigated a removal effect of an electrochemical-ozone coupling system using CuFe-LDH/GF as a cathode on actual wastewater, which specifically includes the following steps:
(1) using the CuFe-LDH/GF in Example 1 as a cathode and a platinum sheet (2×4 cm) as an anode, where a distance between the cathode and the anode is 2 cm;
(2) selecting municipal nanofiltration concentrated water as target wastewater, with basic physicochemical properties shown in Table 2; and using a reaction solution with a volume of 400 mL, adjusting a concentration of gas-phase ozone to 30 mg/L, adjusting a gas flow velocity to 200 mL/min⁻¹, and adjusting a water bath temperature to 25° C.; and

TABLE 2
Basic physicochemical properties of municipal
nanofiltration concentrated water

| Indicator | Parameter | Indicator | Parameter |
|---|---|---|---|
| Water | 15 | Chroma/degree | <5 |
| temperature/° C. | | | |
| Turbidity/NTU | 0.032 | pH | 7.7 |
| Visually observable | None | UV₂₅₄ | 0.184 |
| matter | | | |
| DOC (mg· L⁻¹) | 16.38 | Electrical conductivity | 1191 |
| | | (μs · cm⁻¹) | |
| Inorganic carbon | 44.52 | Redox potential (m V) | −57 |
| (mg·L⁻¹) | | | |

(3) using a direct-current power supply to provide a current density of 2 mA/cm², setting a power-on duration at 20 minutes, extracting 5 mL of the reaction solution within a predetermined time, and detecting total dissolved organic carbon (DOC) remaining in water by a TOC meter.

As shown in FIG. 10, within a treatment time of 60 minutes, the removal rates of DOC of ozonation, an electrochemical-ozone coupling system using GF as a cathode, and the electrochemical-ozone coupling system using the CuFe-LDH/GF as the cathode were 35.9%, 53.1%, and 61.6%, respectively. The results indicated that the system of the present invention had a higher organic matter removal capability in the treatment of actual wastewater and showed a good practical application potential.

In summary, the electrochemical-ozone coupling system based on the CuFe-LDH loaded graphite felt cathode proposed in the present invention effectively combines advantages of electrochemical oxidation and ozonation, compensates for the deficiencies of low treatment efficiency of the electrochemical oxidation and poor mineralization rate of the ozonation, reduces a quenching effect of H₂O₂ on HO· in conventional electrochemical-ozone coupling systems, and improves the utilization rate of HO·, thus being a relatively clean and efficient advanced oxidation technology for water treatment.

In the electrochemical-ozone coupling system, current studies on functional modification of carbon cathodes are relatively few and mainly focus on loading of carbon nanomaterials or metal oxides, which often require a high-temperature calcination process and may cause secondary pollution and material deformation. The loading modification of LDH in the method of the present invention adopts a mild hydrothermal synthesis method, the method is relatively simple, and the synthesized cathode material is relatively stable.

The graphite felt cathode material used in specific examples of the present invention is low in cost and readily available, the modified graphite felt cathode maintains good stability in the system, the removal efficiency of oxalic acid still remains above 90% after cyclic use 5 times, and mass concentrations of leached Fe and Cu elements are <0.06 mg/L and are lower than the National Hygienic Standard for Drinking Water (GB5749-2022).

Compared with electrochemical oxidation, ozonation, and an electrochemical-ozone coupling system using unmodified graphite felt as a cathode, the electrochemical-ozone coupling system based on the CuFe-LDH/GF cathode used in this method obviously increases the removal rate of organic matter.

The examples described above are merely preferred solutions of the present invention and are not intended to limit the present invention. For those of ordinary skill in the relevant technical field, various changes and variations can also be made without departing from the spirit and scope of the present invention. Therefore, any technical solutions obtained by means of equivalent substitution or equivalent transformation shall fall within the scope of protection of the present invention.

1. A method for removing organic matter from water using an electrochemical-ozone coupling system based on an layered double metal hydroxide (LDH)-loaded graphite felt cathode, comprising:
using MFe-LDH/GF as a cathode, wherein M is Cu, Mn, Co, or Ni; using a platinum sheet as an anode; using a reaction solution comprising a pollutant and an electrolyte, wherein the electrolyte is Na₂SO₄; adding the two electrodes into the reaction solution, and introducing gas-phase ozone into the reaction solution; adjusting a pH of the reaction solution to 3-9; and introducing a current to the two electrodes to construct the electrochemical-ozone coupling system to remove the pollutant.

2. The method for removing organic matter from water using an electrochemical-ozone coupling system based on an LDH-loaded graphite felt cathode according to claim 1, wherein the Mfe-LDH/GF is used as the cathode, wherein M is Cu.

3. The method for removing organic matter from water using an electrochemical-ozone coupling system based on an LDH-loaded graphite felt cathode according to claim 1, wherein the pH of the reaction solution is 5-7.

4. The method for removing organic matter from water using an electrochemical-ozone coupling system based on an LDH-loaded graphite felt cathode according to claim 1, wherein a density of the current introduced to the two electrodes is 2-5 mA/cm².

5. The method for removing organic matter from water using an electrochemical-ozone coupling system based on an LDH-loaded graphite felt cathode according to claim 1, wherein a concentration of the gas-phase ozone is 15-60 mg/L, and a flow velocity of the gas-phase ozone is 100-300 mL/min.

6. The method for removing organic matter from water using an electrochemical-ozone coupling system based on an LDH-loaded graphite felt cathode according to claim 1, wherein in the reaction solution, a concentration of Na₂SO₄ is 30-70 mmol/L, and a concentration of the pollutant is 30-60 mg/L.

7. The method for removing organic matter from water using an electrochemical-ozone coupling system based on an LDH-loaded graphite felt cathode according to claim 1, wherein the pollutant is oxalic acid, pyruvic acid, or acetic acid.

8. The method for removing organic matter from water using an electrochemical-ozone coupling system based on an LDH-loaded graphite felt cathode according to claim 1, wherein H₂SO₄ and NaOH are added into the reaction solution to adjust the pH value, a concentration of H₂SO₄ is 0.05-0.2 mol/L, and a concentration of NaOH is 0.05-0.2 mol/L.

9. The method for removing organic matter from water using an electrochemical-ozone coupling system based on an LDH-loaded graphite felt cathode according to claim 1, wherein a method for preparing the Mfe-LDH/GF comprises:
thoroughly dissolving Fe(NO₃)₃·9H₂O, M(NO₃)₂·3H₂O, CO(NH₂)₂, and NH₄F in ultrapure water to obtain an LDH mother solution, wherein mass concentrations of Fe(NO₃)₃·9H₂O, M(NO₃)₂·3H₂O, CO(NH₂)₂, and NH₄F are 9-23 g/L, 13-26 g/L, 20-35 g/L, and 1-3 g/L, respectively; and
adding graphite felt into the LDH mother solution to obtain a mixed solution, allowing the mixed solution to undergo a hydrothermal reaction at a temperature of 90-120° C. for a reaction time of 8-16 hours, and after the reaction is completed, performing suction filtration, washing, and drying to obtain the Mfe-LDH/GF.

10. The method for removing organic matter from water using an electrochemical-ozone coupling system based on an LDH-loaded graphite felt cathode according to claim 1, wherein before graphite felt is added into an LDH mother solution, a surface of the graphite felt is sequentially washed with acetone and ultrapure water, dried, and oven-dried.

11. The method for removing organic matter from water using an electrochemical-ozone coupling system based on an LDH-loaded graphite felt cathode according to claim 6, wherein the pollutant is oxalic acid, pyruvic acid, or acetic acid.
